(19) United States
(12) Patent Application Publication
(10) Pub. No.: US 2003/0170037 A1
(43) Pub. Date: Sep. 11, 2003

(54) Media installation sensor/indicator for use in a multipurpose (MP) tray in a printing device

(76) Inventor: Sunny E. Hill, Caldwell, ID (US)

Correspondence Address: HEWLETT-PACKARD COMPANY, Intellectual Property Administration, P.O. Box 272400, Fort Collins, CO, 80527-2400, US

(21) Appl. No.: 10/092,240

(22) Filed: Mar. 6, 2002

(51) Int. Cl. G03G 15/00

(52) U.S. Cl. 399/23

(57) ABSTRACT

This invention relates to media sensors for multipurpose (MP) trays. MP trays are, typically, located along a side of a printer and allow the user to install a variety of media, such as transparencies, which can be printed by the printer. Such structures of this type, generally, provide immediate visual/audio feedback to the user regarding whether or not the media was properly installed in the MP tray.

### FIELD OF THE INVENTION

This invention relates to media sensors for multipurpose (MP) trays. MP trays are, typically, located along a side of a printer and allow the user to install a variety of media, such as transparencies, which can be printed by the printer. Such structures of this type, generally, provide immediate visual/audio feedback to the user regarding whether or not the media was properly installed in the MP tray.

### DESCRIPTION OF THE RELATED ART

Typically, when a user needs to print on a specialized media, such as a transparency, that is not available in the bins/trays of the printer, the user must install this specialized media into the MP tray. A common error usually results from this installation of the specialized media in that the user slides the specialized media into the tray and assumes the specialized media is properly installed, but frequently forgets to check to see if the specialized media is properly installed. If the specialized media is not properly installed, the printer will automatically pull media from a default bin/tray that is usually not what the user wants to print the document upon. The user then returns to the printer only to find out that the document was not printed upon the desired specialized media and must do the process all over again. However, if the user still has not properly installed the specialized media, the document will continue to be printed upon the default media which can result in the needless waste of media. Consequently, a more advantageous system, then, would be presented if the user were immediately notified that the specialized media was not properly installed in the MP tray.

It is known, in the printing art, to employ sensors for a variety purposes. Exemplary of such prior art are U.S. Pat. No. 5,101,240 ('240) to P. T. Pendell et al., entitled “System for Aligning a Printer with a Finisher,” U.S. Pat. No. 5,103,259 ('259) to T. Saitoh et al., entitled “Image Forming Apparatus Having a Sensor for Checking Mounted Units,” and U.S. Pat. No. 6,343,198 ('198) to T. Sato, entitled “Image Forming Apparatus Including Interlocking Light Emitting and Receiving Portions.” The '240, '259, and '198 references disclose various sensors for use in printing apparatus. For example, sensors are disclosed that show when the various parts of the printing device are properly connected/aligned. However, none of these references employ a sensor for use in a MP tray. Consequently, a more advantageous system, then, would be presented if the printer were provided with a MP tray that had a media installation sensor/indicator device.

It is also known, in the printing art, to employ media sensors. Exemplary of such prior art are U.S. Pat. No. 5,574,551 ('551) to J. A. Kazakoff, entitled “Print Media Supply Apparatus with Media Parameter Detection Capability” and commonly assigned, U.S. Pat. No. 6,213,659 ('659) to S. B. Elgee, entitled “Print Medium Loading Error Detection for Use in Printing Devices.” While the '551 and '659 references utilize sensors to detect a variety of media conditions, none of these references employ sensors in the MP tray. Consequently, a still further advantageous system, then, would be presented if the printer were provided with a sensor in the MP tray that would provide immediate feedback to the user as to whether or not the media was properly installed in the MP tray.

It is apparent from the above that there exists a need in the art for a media sensing/indicating system which is lightweight through simplicity of parts and uniqueness of structure, and which at least equals the media sensing/indicating systems of the prior art, but which at the same time employs a media sensing/indicating system on the MP tray that will provide immediate feedback to the user as to whether or not the media is properly installed in the MP tray. It is a purpose of this invention to fulfill this and other needs in the art in a manner more apparent to the skilled artisan once given the following disclosure.

### SUMMARY OF THE INVENTION

Generally speaking, this invention fulfills these needs by providing a media installation sensor/indicator system for use in a multipurpose (MP) tray in a printing device, wherein the system is comprised of: a printing device having a MP tray and at least one media installation sensor/indicator means located on the MP tray such that the media installation sensor/indicator means is operable when media is being installed in the MP tray and the media installation sensor/indicator means senses/indicates if the media is properly installed in the MP tray.

In certain preferred embodiments, the printing device can be, but is not limited to, a printer, a facsimile machine, a photocopier or the like. Also, the media installation sensor/indicator means can be, but is not limited to, an audio/visual signaling device. Finally, the media being installed in the MP tray can be, but is not limited to, any type of specialty media, such as a transparency.

In another further preferred embodiment, the proper installation of the media in the MP tray can be quickly determined so that the user will print the document on the desired media and not waste media.

The preferred media installation sensor/indicator system, according to this invention, offers the following advantages: lightness in weight; ease of assembly and repair; use in an MP tray; excellent media installation sensing/indicating means; and good economy. In fact, in many of the preferred embodiments, these factors of lightness in weight, use in an MP tray, and media installation sensing/indicating means are optimized to an extent that is considerably higher than heretofore achieved in prior, known media installation sensor/indicator systems.

The above and other features of the present invention, which will become more apparent as a description proceeds, are best understood by considering the following detailed description in conjunction with accompanying drawings, wherein like characters represent like parts throughout the several views and in which:

### BRIEF DESCRIPTION OF THE DRAWINGS

FIG. 1 is a side plan view of a printing device having its multipurpose (MP) tray opened to expose the media installation sensing/indicating means, according to one embodiment of the present invention; and

FIG. 2 is a more detailed side plan view of the opened MP tray and its exposed media installation sensing/indicating means.

### DETAILED DESCRIPTION OF THE INVENTION

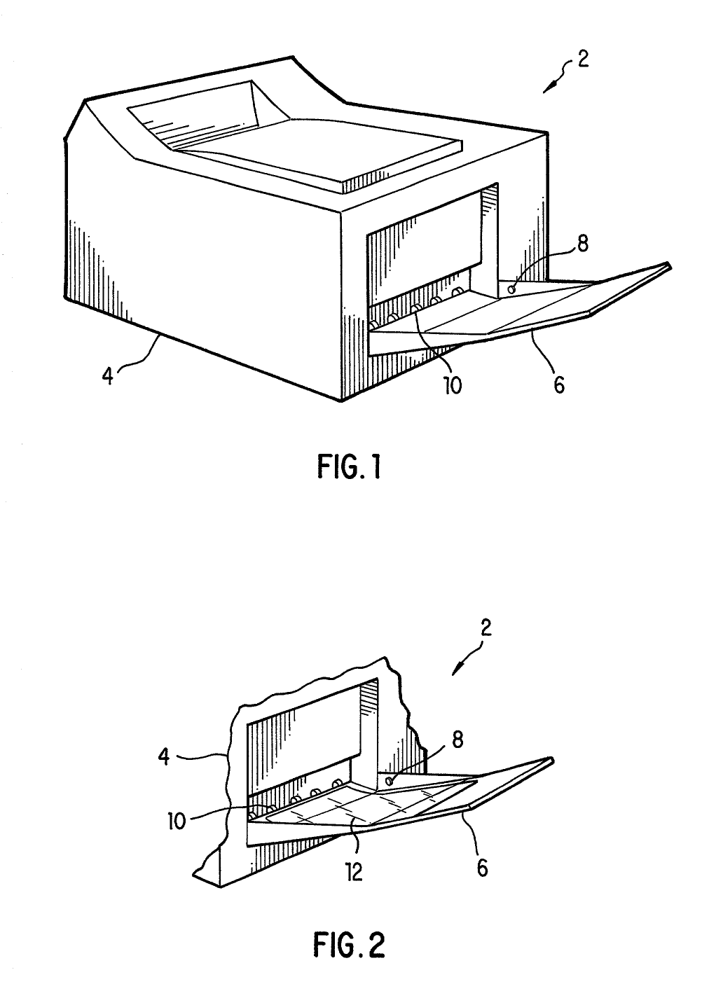

With reference first to FIG. 1, there is illustrated one preferred embodiment for use of the concepts of this invention. As shown in FIG. 1, media installation sensor/indicator system 2 is illustrated. System 2 includes, in part, printing device 4, multipurpose (MP) tray 6, media installation sensor/indicator means 8, and conventional printing device rollers 10.

Media installation sensor/indicator means 8 can be, but is not limited to, an audio/visual means. For example, a single LED can be located along the upper side of tray 6. However, a plurality of LEDs can be located along both sides of the upper side of tray 6. Also, an audio means, such as a beeping device, can also be located in conjunction with or instead of the LEDs, as discussed above. It is to be understood that location of the media installation sensor/indicator means 8 must provide the user with substantially immediate feedback as to whether or not the user has properly installed the media in the MP tray 6.

FIG. 2 shows a more detailed view of the opened MP tray 6. As shown in this Figure, a specialized media 12, such as a transparency, is installed in MP tray 6. If properly installed, media installation sensor/indicator means 8 will, for example, light up if the LED, as described above, is used. It is to be understood that other types of specialized media, such as legal paper, glossy paper and other types of specially coated papers can also be installed in MP tray 6, along with the standard sizes of paper.

With respect to the operation of system 2, if the user determines that a document needs to be printed upon media 12 that is not currently available in the desired printer, the user can open the MP tray 6 of printer 4 in order to install media 12 in MP tray 6. In this manner, the user slides media 12 along MP tray 6 until media 12 contacts rollers 10, as shown in FIG. 2. If media 12 is properly installed in MP tray 6, media installation sensor/indicator means 8 will, for example, light up if the LED, as described above, is used. If the user is physically handicapped, such as blind or colorblind, an audio media installation sensor/indicator means 8 can be employed which would emit an audio signal, such as a beep, when media 12 was properly installed in MP tray 6.

With respect to media installation sensor/indicator means 8, there are a variety of devices that can be employed. As discussed above, a LED or a plurality of LEDs can be used. With respect to these LEDs, the color of the LED can be changed from, for example, red to green, when media 12 is properly installed in MP tray 6. With respect to an audio media installation sensor/indicator means 8, a variety of audible sounds can be utilized as long as the sound adequately alerts the user to a possible improperly/properly installed media 12.

Once given the above disclosure, many other features, modifications or improvements will become more apparent to the skilled artisan. Such features, modifications or improvements are, therefore, considered to be a part of this invention, the scope of which is to be determined by the following claims.

What is claimed is:

1. A media installation sensor/indicator system for use in a multipurpose (MP) tray in a printing device, comprising:
a printing device having a MP tray; and
at least one media installation sensor/indicator means located on said MP tray such that said sensor/indicator means is operable when media is being installed in said MP tray and said sensor/indicator means senses/indicates if said media is properly installed in the MP tray.

2. The system, as in claim 1, wherein said printing device is further comprised of:
a printer.

3. The system, as in claim 1, wherein said printing device is further comprised of:
a facsimile machine.

4. The system, as in claim 1, wherein said printing device is further comprised of:
a photocopying machine.

5. The system, as in claim 1, wherein said media installation sensor/indicator means is further comprised of:
a LED.

6. The system, as in claim 1, wherein said media installation sensor/indicator means is further comprised of:
a plurality of LEDs.

7. The system, as in claim 1, wherein said media installation sensor/indicator means is further comprised of:
an audio signal emitting device.

8. A method for sensing/indicating the proper installation of media in a multipurpose (MP) tray in a printing device, comprising the steps of:
determining by a user if a desired media upon which a document is to be printed is available in a printing device;
installing said the desired media in a multipurpose tray in said printing device; and
sensing/indicating that said the desired media has been properly installed in said multipurpose tray through at least one media installation sensor/indicator means located on said MP tray such that said sensor/indicator means is operable when media is being installed in said MP tray and said sensor/indicator means senses/indicates if said media is properly installed in the MP tray.

9. The method, as in claim 8, wherein said sensing/indicating step is further comprised of the step of:
audibly/visually notifying said the user that said desired media has been properly installed in said multipurpose tray.

10. The method, as in claim 8, wherein said audibly/visually notifying step is further comprised of the step of:
operating a LED.

11. The method, as in claim 8, wherein said audibly/visually notifying step is further comprised of the step of:
operating a plurality of LEDs.

12. The method, as in claim 8, wherein said audibly/visually notifying step is further comprised of the step of:
operating an audio means.

13. A program storage medium readable by a computer, tangibly embodying a program of instructions executable by said computer to perform method steps for:
determining by a user if a desired media upon which a document is to be printed is available in a printing device;
installing said the desired media in a multipurpose tray in said printing device; and
sensing/indicating that said the desired media has been properly installed in said multipurpose tray through at least one media installation sensor/indicator means located on said MP tray such that said sensor/indicator means is operable when media is being installed in said MP tray and said sensor/indicator means senses/indicates if said media is properly installed in the MP tray.

14. The method, as in claim 13, wherein said sensing/indicating step is further comprised of the step of:
audibly/visually notifying said the user that said desired media has been properly installed in said multipurpose tray.

15. The method, as in claim 13, wherein said audibly/visually notifying step is further comprised of the step of:
operating a LED.

16. The method, as in claim 13, wherein said audibly/visually notifying step is further comprised of the step of:
operating a plurality of LEDs.

17. The method, as in claim 13, wherein said audibly/visually notifying step is further comprised of the step of:
operating an audio means.
